(19) United States
(12) Patent Application Publication
(10) Pub. No.: US 2021/0117358 A1
(43) Pub. Date: Apr. 22, 2021

(54) VIRTUAL MULTICHANNEL STORAGE CONTROL

(71) Applicants: Brian J. LePage, Eagan, MN (US); Carl R. Crandall, Eagan, MN (US)

(72) Inventors: Brian J. LePage, Eagan, MN (US); Carl R. Crandall, Eagan, MN (US)

(73) Assignee: Unisys Corporation, Blue Bell, PA (US)

(21) Appl. No.: 16/803,396

(22) Filed: Feb. 27, 2020

Related U.S. Application Data
(63) Continuation of application No. 16/658,269, filed on Oct. 21, 2019.

(51) Int. Cl. G06F 13/40; G06F 13/16; G06F 9/455; H04L 29/06

(52) U.S. Cl. CPC G06F 13/4027; G06F 13/1668; G06F 2009/45579; H04L 63/0428; G06F 9/45558

(57) ABSTRACT

A computing system includes a computer executing an emulated operating system, the emulated operating system including a multichannel control unit; a plurality of virtual drives accessible to the emulated operating system; and a communication channel, the communication channel connecting the multichannel control unit and the virtual drives through one or more virtual channels. The multichannel control unit sends a first data access request to a virtual drive through the first virtual channel of the communication channel, the multichannel control unit sends a second data access request to a virtual drive through the second virtual channel of the communication channel.

### FIELD OF THE DISCLOSURE

The present invention relates generally to computer architecture and internet infrastructure for storage access of virtual machines (emulated systems). More particularly, the present invention relates to increased speed in accessing virtual drives using virtual multichannel storage control, wherein the virtual multichannel is established over a single communication channel.

### BACKGROUND

Virtual disk is an emulated hard drive, also known as logical hard drive. In most cases, a virtual disk is a file hosted on a physical hard drive, also known as disk-in-a-file. A virtual disk can be setup in a non-emulated operating system and/or an emulated operating system. For example, a virtual disk can be established under Linux, a non-emulated operating system, or a virtual disk can be established under Clear path OS 2200, an emulated operating system.

The data throughput of one or multiple virtual disks hosted on a physical hard drive is limited because the physical hard drive is accessed through a single communication channel. Only one data access request can be processed at a given time through a communication channel. After a data access request of a virtual drive is sent to the physical hard drive through the communication channel, there is a response latency before the data in interest is returned. Thus, the entire data throughput of the communication is limited because after one request is sent, the system idles and waits for at least the response latency to receive the desired data. The response latency causes a bandwidth limitation.

The embodiments of this disclosure aim to provide solutions to significantly increase the communication bandwidth using the same single communication channel.

### SUMMARY

The present invention relates generally to computer architecture and internet infrastructure for storage access in virtual machines (emulated systems). More particularly, the present invention relates to increased speed in accessing virtual drives using virtual multichannel storage control, wherein the virtual multichannel is established over a single communication channel.

The data throughput of one or multiple virtual disks hosted on a physical hard drive is limited because the physical hard drive is accessed through a single communication channel. Traditionally, only one data access request can be processed at a given time through a communication channel. After a data access request of a virtual drive is sent to the physical hard drive through the communication channel, there is a response latency before the data in interest is returned. Thus, the entire data throughput of the communication is limited because after one request is sent, the system idles and waits for at least the response latency to receive the desired data. The response latency causes a bandwidth limitation.

The embodiments disclosed herein involves establishing multiple virtual communication channels over a single communication channel. In one embodiment, multiple virtual channels are established by sending multiple data access requests during the response latency.

In one embodiment, there is a first data request for a first virtual drive and a second data request for a second virtual drive. Between the first data request and the second data request there is a time gap (Tg). The Tg is shorter than the response latency (T). In one embodiment, Tg is 0.5T and the communication bandwidth can be doubled. In one embodiment, the Tg is 0.33T and the communication bandwidth can be tripled. In yet another embodiment, the Tg is 0.25T and the communication bandwidth can be quadrupled, so on and so forth.

According to one embodiment, a computing system includes a computer executing an emulated operating system, the emulated operating system including a multichannel control unit; a first virtual drive accessible to the emulated operating system; a second virtual drive accessible to the emulated operating system; and a communication channel, the communication channel connecting the multichannel control unit and the first virtual drive and the second virtual drive. The multichannel control unit sends a first data access request to the first virtual drive through the communication channel, the multichannel control unit sends a second data access request to the second virtual drive through the communication channel. The time interval between the first and second data requests being sent is shorter than a virtual drive's response latency.

According to another embodiment, a computing system includes a processor, a machine readable memory accessible by the processor, and a communication channel connecting the computing system with a plurality of virtual drives (VDs). The machine readable memory stores instructions when executed cause the processor to perform following actions: receiving a first request to access a first VD of an emulated machine; creating a file handle for the first request; putting the first request in a queue; sending the first request to the first VD through the communication channel; sending a second request to a second VD designated by the second request through the communication channel, wherein the second VD has a response latency; wherein an interval between sending the first request and the second request is shorter than the response latency.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1A is a schematic diagram of the virtual multichannel communication system according to one embodiment of the disclosure.

FIG. 1B is a schematic diagram of the virtual multichannel communication system according to one embodiment of the disclosure.

FIG. 2A is an illustration of a traditional communication scheme to one or more virtual drives hosted on a single hard drive according to a known art.

FIG. 2B is an illustration of a virtual multichannel communication scheme wherein multiple requests are sent to a same virtual drive according to one embodiment of the disclosure.

FIG. 2C is an illustration of a virtual multichannel communication scheme wherein multiple requests are sent to different virtual drives according to one embodiment of the disclosure.

FIG. 3 is a method of creating one or more virtual channels to one or more virtual drives according to one embodiment of the disclosure.

FIG. 4 is a method to access a plurality of virtual drives with a first-in first-out que according to one embodiment of the disclosure.

FIG. 5 is a method to access a plurality of virtual drives with a prioritized que according to one embodiment of the disclosure.

FIG. 6 is a block diagram illustrating a computer network according to one embodiment of the disclosure.

FIG. 7 is a block diagram illustrating a computer system according to one embodiment of the disclosure.

FIG. 8A is a block diagram illustrating a server hosting an emulated software environment for virtualization according to one embodiment of the disclosure.

FIG. 8B is a block diagram illustrating a server hosting an emulated hardware environment according to one embodiment of the disclosure.

### DETAILED DESCRIPTION

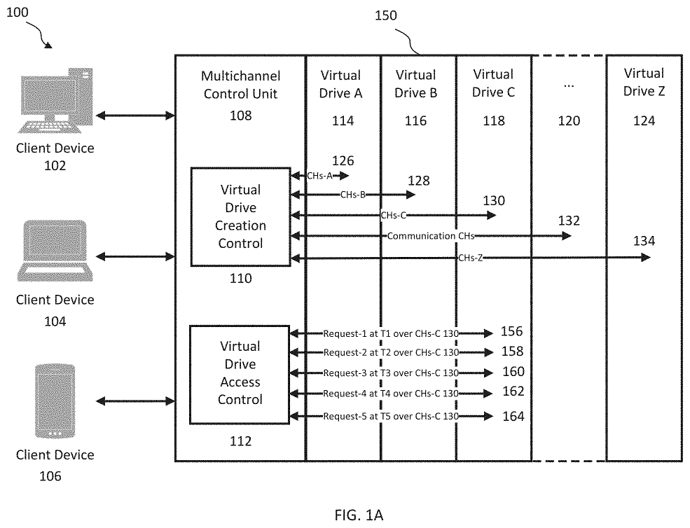

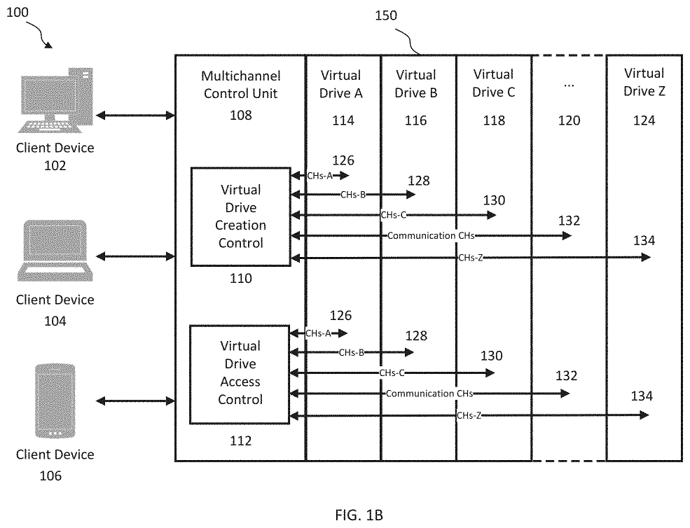

FIG. 1A is a schematic diagram of the virtual multichannel communication system (hereinafter “system” as referring to the embodiment of FIG. 1) 100 according to one embodiment of the disclosure. The system 100 includes client devices 102, 104, and 106. The client devices 102, 104, 106 can be any personal device, e.g., desktop computer, laptop computer, cell phone, etc., that can communicate with a virtual machine 150 through physical and/or wireless connection.

The virtual machine 150 can include an emulated operating system (OS). The virtual machine 150 includes a multichannel control unit 108. In one embodiment, the multichannel control unit 108 can be a physical machine with processor and accessible machine readable memory. In another embodiment the multichannel control unit 108 can be software implemented logical functions. The multichannel control unit 108 includes a virtual drive creation control 110 and virtual drive access control 112.

The client devices 102, 104, 106 can request creation of a virtual drive. The multichannel control unit 108 receives the request and use the virtual drive creation control 110 to create the virtual drive as well as the communication channel to the drive.

As shown in FIGS. 1A and 1B, the virtual drive creation control 110 can create virtual drive A 114 and its corresponding one or more virtual communication channels 126; virtual drive B 116 and its corresponding one or more virtual communication channels 128; virtual drive C 118 and its corresponding one or more virtual communication channels 130; virtual drive Z 124 and its corresponding one or more virtual communication channels 134; and/or any virtual drive 120 and its corresponding one or more virtual communication channels 132. For each virtual drive (e.g., A 114, B 116, C 118, . . . 120, Z 124), a plurality of virtual channels (e.g., 126, 128, 130, 132, 134) can be set up.

The virtual drives 114, 116, 118, 120, 124 and their respective one or more virtual communication channels 126, 128, 130, 132, 134 can be created together or separately all at once or on demand. In one embodiment, the virtual communication channels 126, 128, 130, 132, 134 are implemented over a single non-virtual communication channel. That says, in the embodiment, the virtual communication channels 126, 128, 130, 132, 134 are logical and are implemented over a single physical (the term “physical” is used in contrast with virtual) communication channel that can be wired or wireless.

In one embodiment, the virtual drive creation control 110 receives a request from a client device 102, 104, 106 to create a virtual drive on virtual machine 150. In one embodiment, a user of a client device 102, 104, 106 may want to create a virtual drive with specific access controls. For example, a user may want to limit the access to the virtual drive to him/herself. In another example, a user may want to limit the access to the virtual drive to a community-of-interest, e.g., colleagues in the same office or departments, members of a team, etc. Thus, the request may include parameters for setting up the access control. These access control parameters may include the identities of the user/client devices that can access the virtual drives, the capacity of those user/client devices, e.g., read, write, delete, etc.

In one embodiment, according to the request, the virtual drive creation control 110 creates a partition on one or more physical hard drives accessible by the virtual machine 150. This partition provides machine readable memory to support the functionalities of the virtual drive to be created. In one embodiment, this partition can be hosted on a single hard drive. In another embodiment, this partition can be hosted on a plurality of hard drives, e.g., cloud storage. In one embodiment, this partition has a fixed size. In another embodiment, this partition is scalable.

In one embodiment, the virtual drive creation control 110 creates an identifier, e.g., an access key, for the virtual drive. This identifier may include a name, a serial number, a logical identifier, an access key, etc. The access key can also be used for encryption/decryption functionalities to establish an encrypted communication between a client and a specific drive. This access key may be private to the client. In another embodiment, this access key can be public. Yet, in another embodiment, the access key can be shared among a community-of-interest.

In one embodiment, the virtual drive creation control 110 establishes one or more virtual communication channels for the virtual drive newly created. The virtual communication channels for the virtual drive are established, at least in part, using the identifier, e.g., the access key. In one embodiment, this means the information conveyed on the specific virtual channels is encrypted using the identifier, e.g., the access key. In another embodiment, this means when requesting information from the virtual drive, the request must include the access key.

As shown in FIG. 1A, the virtual drive access control 112 may send a plurality of requests 156, 158, 160, 162, 164 over the plurality of virtual channels 130 specific for virtual drive C 118. The plurality of requests 156, 158, 160, 162, 164 are sent through different timings. The first request 156 is sent on T1. The second request 158 is sent on T2. The third request 160 is sent on T3. The fourth request is sent on T4. The fifth request is sent on T5. It is specifically noted that the virtual drive access control 112 can send a plurality of access requests to any of the virtual drives, not limited to virtual drive C. FIG. 1A is merely an example of an embodiment, and shall not be construed as limiting the scope of the claims in any manner.

In one embodiment, the virtual drive C has a response time (T) which is a time period required for virtual drive C 118 to respond to an access request. As previously mentioned, the plurality of requests 156, 158, 160, 162, 164 are sent through different timings (The first request 156 is sent on T1. The second request 158 is sent on T2. The third request 160 is sent on T3. The fourth request is sent on T4. The fifth request is sent on T5. In one embodiment, the time gap between T2 and T1 is shorter than response time (T), which can be expressed as T2−T1≤T. Similarly, the time gap between T3 and T2 is shorter than response time (T): T3−T2≤T; the time gap between T4 and T3 is shorter than response time (T): T4−T3≤T; the time gap between T5 and T4 is shorter than response time (T): T5−T4≤T. In another embodiment, as T1 is earlier in time than T2, T2 earlier in time than T3, T3 earlier in time than T4, T4 earlier in time than T5, and the time gap between T5 and T1 is shorter than the response time, such that T5−T1≤T.

FIG. 1B is an embodiment, showing virtual drive access control 112 can send a plurality of requests over channels 126 to virtual drive A, over channels 128 to virtual drive B, over channels 130 to virtual drive C, over channels 132 to any drive, and over channels 134 to drive Z.

In one embodiment, when the virtual channels 126, 128, 130, 132, 134 are established, each of them can have a plurality of access keys generated. For example, a master key if presented by the requestor, the requestor can have full capacity to the particular virtual drive 114, 116, 118, 120, 124, e.g., read, write, delete, edit, etc. In another example, a read only key when presented by the requestor, the requestor can only read the files on the virtual drive. In another embodiment, a read-and-write key when presented by the requestor, the requestor can read and write the file on the virtual drive.

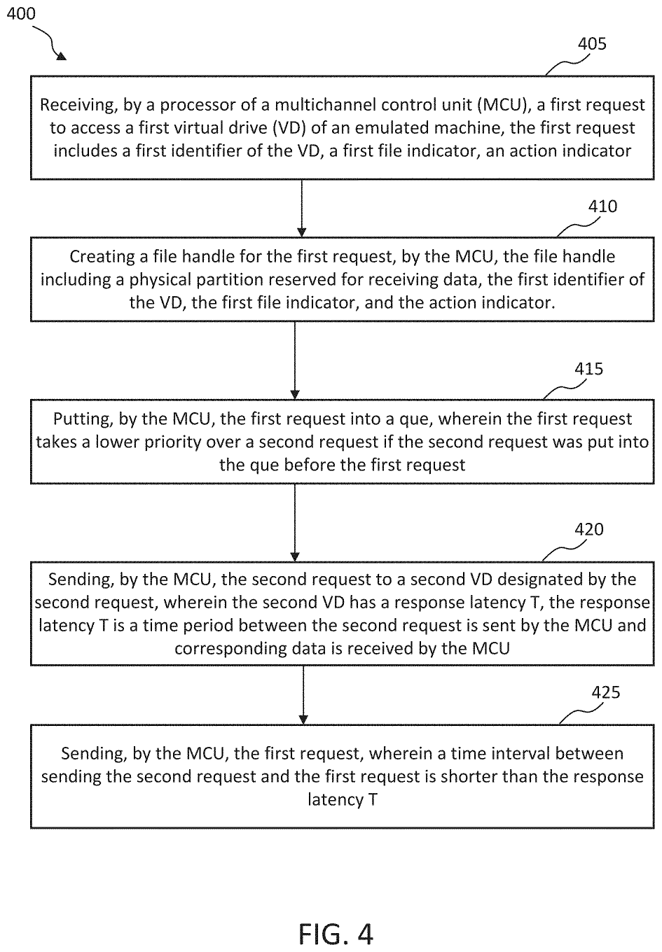

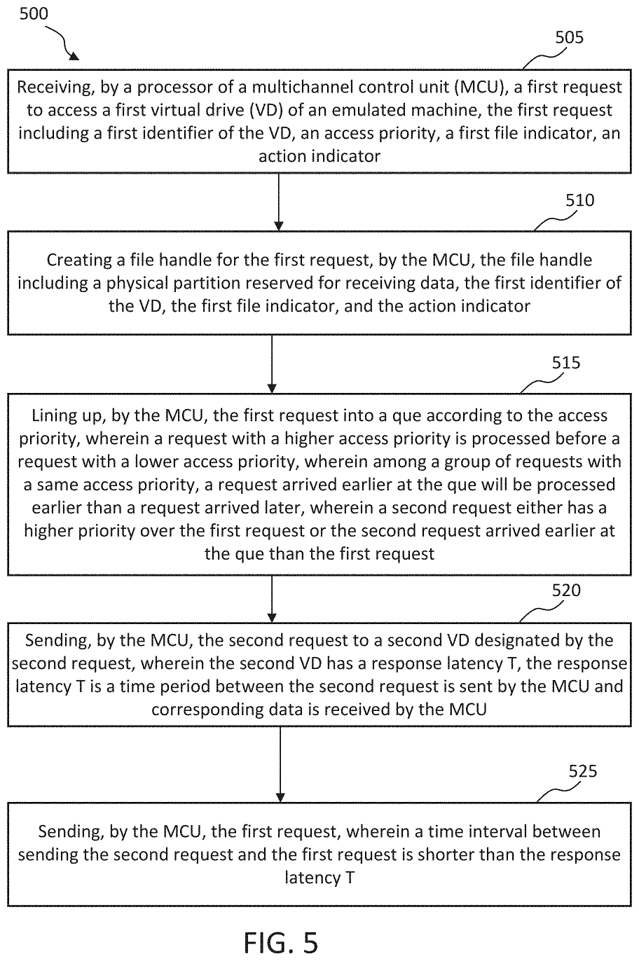

The virtual drive access control 112 assists the client devices 102, 104, and 106 to access data stored in the virtual drives 114, 116, 118, 120, 124. The drive access control 102 receives the data access request and access the intended virtual drive and the intended data hosted on the drive. Various methods, such as method 400 shown in FIG. 4 and method 500 shown in FIG. 5 can be used to access the data hosted on the virtual drives 114, 116, 118, 120, 124.

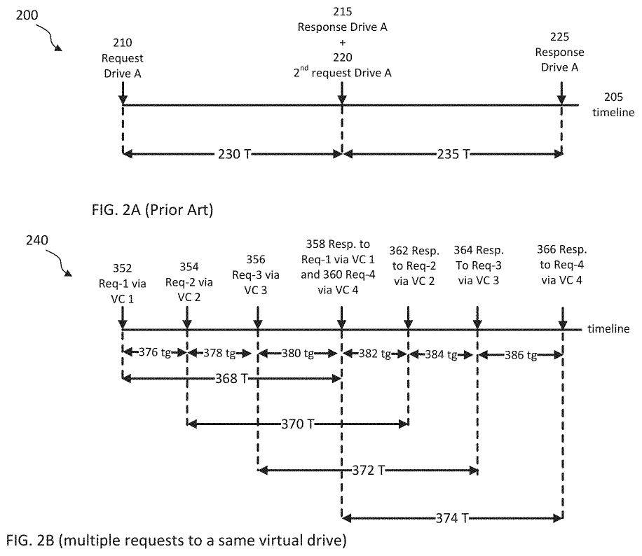

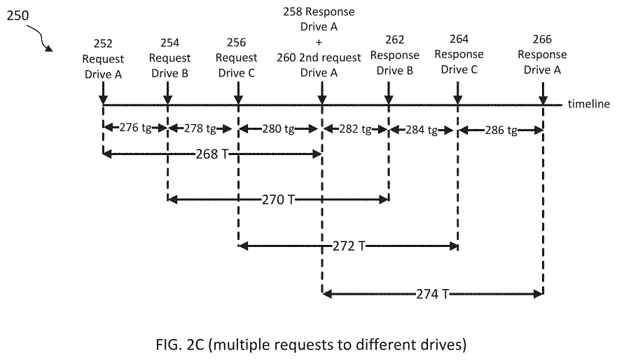

FIG. 2A (Prior Art) is an illustration of a traditional communication scheme 200 to one or more virtual drives hosted on a single hard drive known in the art. The communication scheme 200 is shown as an example of using a single physical communication channel. The term “physical communication channel” refers to non-virtual communication channel. The physical communication channel can be wired, wireless, or a combination thereof.

As shown in FIG. 2A, a data access request 210 to drive A is sent at the time point on the timeline 205. There is a time latency T 230 between the time of the request 210 being sent and a response 215 being received. The time latency T 230 can be caused by various reasons, e.g., data connection quality, instruction processing speed, CPU frequency, hard drive data access speed (e.g., disk drive or solid state drive), etc.

FIG. 2A shows an over simplified scenario where the second data access request 220 to drive A is placed at the same time as the response 215 from drive A to the first data access request 210. In a realistic scenario, there should a small latency between the placement of the second data request 220 and the response 215 to the first request 210. However, for the purpose of the embodiment shown in FIG. 2A, the small latency between 215 and 220 can be ignored.

After the second data access request 220 is placed, there is another latency T 235 before receiving the corresponding response 225. Latency T 230 and latency T 235 can be the same or different. As shown in FIG. 2A, during the latency T 230 and latency T 235, there is no data communication. During the latency T 230 and latency T 235, the entire communication idles and waits for the virtual drive to respond. Thus, in FIG. 2A, the data throughput, also known as communication bandwidth, is limited by the response latency.

FIG. 2B is an illustration of a virtual multichannel communication scheme 240 to one or more virtual drives hosted on a single hard drive according to one embodiment of the disclosure. In contrast to FIG. 2A (prior art), FIG. 2B shows an embodiment of the disclosure that establishes a plurality of virtual channels that utilizes the response latency period to send multiple data access requests and receives multiple response through a single non-virtual communication channel.

In the embodiment of FIG. 2B, there are four virtual channels: VC 1, VC 2, VC 3, and VC 4, each providing a communication path to a same virtual drive. This single virtual drive can be any virtual drive, e.g., virtual drive A 114, virtual drive 116, virtual drive 118, . . . 120, or virtual drive 124.

In one embodiment, a multichannel control unit (MCU) may send a first data access (Req-1) 352 via the first virtual channel (VC 1) to the single virtual drive. There is a latency T 368 before the virtual drive respond at 358. During the latency T 368, the MCU may send a second data access request (Reg-2) 354 to the virtual drive through the second virtual channel (VC2); and a third data access request (Reg-3) 356 to the virtual drive through the third virtual channel (VC 3). Thus, during the latency 368 T, three requests (i.e., Req-1, Req-2, and Req-3) are sent, instead of only one as in FIG. 2A. The bandwidth of FIG. 2B is at least three times of FIG. 2A, assuming the response latencies 230 and 368 are the same. In one embodiment, all the virtual channels are established over a single non-virtual channel.

A request through VC2 may have a latency T 370 between the request 354 and the response 362. A request through VC3 may have a latency T 372 between the request 356 and the response 364. The latency T 368, latency T 370, latency T 372, and latency T 374 are independent from each other, e.g., they can be the same and/or they can be different.

There is a first time gap 376 between the first data request (Req-1) 352 and the second data request (Req-2) 354. The first time gap 376 is shorter than the time latency T 368. There is a second time gap 378 between the second data request (Req-2) 354 through VC 2 and the third data request (Req-3) 356 through VC 3. The second time gap 378 is shorter than the time latency T 368. There is a third time gap 380 between the third data request (Req-3) through VC 3 and a fourth data request (Req-4) through VC 4. The time gap 380 is shorter than the time latency T 368. Similarly shown in FIG. 2B, time gap 378, time gap 380, time gap 382 are shorter than time latency 370. Time gap 380, time gap 382, time gap 384 are shorter than time latency 372. Time gap 382, time gap 384, and time gap 384 are shorter than time latency 374.

FIG. 2C is an illustration of a virtual multichannel communication scheme 250 to different virtual drives hosted on a single hard drive according to one embodiment of the disclosure. In contrast to FIG. 2A (prior art), FIG. 2C shows an embodiment of the disclosure that establishes a plurality of virtual channels that utilizes the response latency period to send multiple data access requests and receives multiple response through a single non-virtual communication channel.

In the embodiment of FIG. 2C, there are three virtual channels, each providing a communication path to one or more virtual drives. In one embodiment, a multichannel control unit (MCU) may send a data access request 252 to drive A through the first virtual channel. There is a latency T 268 before Drive A responds at 258. During the latency T 268, the MCU may send a second data access request 254 to Drive A through the second virtual channel; and a third data access request 256 to Drive A through the third virtual channel. Thus, during the latency 268 T, three requests are sent, instead of only one as in FIG. 2A. The bandwidth of FIG. 2B is at least three times of FIG. 2A. In one embodiment, all the virtual channels are established over a single non-virtual channel.

A request through channel B may have a latency T 270 between the request 254 and the response 262. A request through channel C may have a latency T 272 between the request 256 and the response 264. The latency T 268, latency T 270, latency T 272, and latency T 274 are independent from each other, e.g., they can be the same and/or they can be different.

There is a first time gap 276 between the first data request 252 and the second data request 254. The first time gap 276 is shorter than the time latency T 268. There is a second time gap 278 between the second data request 254 through channel B and the third data request 256 through channel C. The second time gap 278 is shorter than the time latency T 268. There is a third time gap 280 between the data request through channel C and a second data request through channel A. The time gap 280 is shorter than the time latency T 268.

In one embodiment, the drive A, drive B, and drive C are all hosted on a single physical hard drive, with a single physical communication channel. The embodiment of FIG. 2B shows the implementation of, at least, three virtual channels implemented over the single physical channel and increased the communication bandwidth by three times. It is noted that FIG. 2B is illustrative only. With sufficiently short time gap between two data requests (e.g., time gap 276, 278, 280), and/or sufficiently short time gap between two data responses (e.g., time gap 282, 284, 286) compared to the response latency (e.g., 268, 270, 272, 274), it is possible to infinitely increase the communication bandwidth by implementing infinite numbers of virtual channels over a single non-virtual channel.

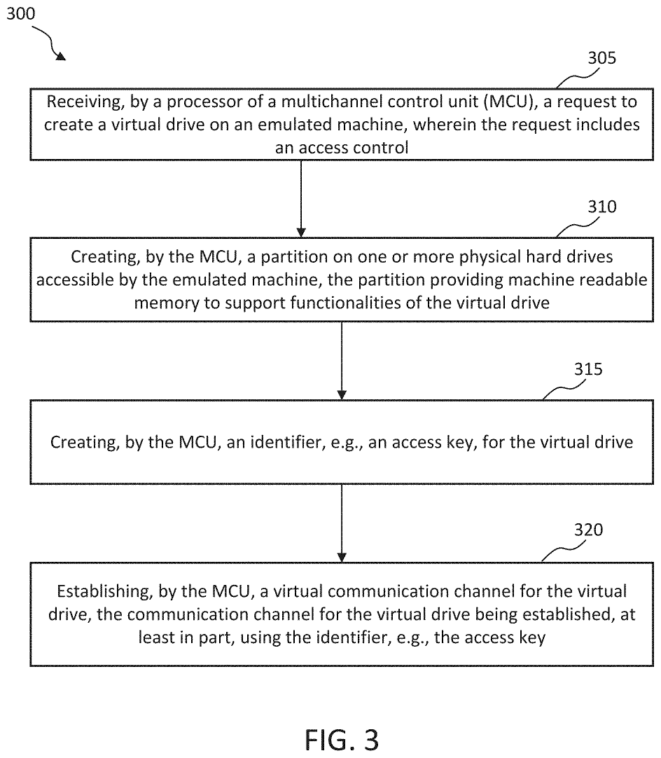

FIG. 3 is a method 300 of creating one or more virtual channels to one or more virtual drives according to one embodiment of the disclosure.

The method 300 includes 305 receiving, by a processor of the multichannel control unit (MCU), a request to create a virtual drive on an emulated machine, wherein the request includes an access control. Method 300 can be applied to the MCU 108. In one embodiment, the MCU 108 receives a request from a client device 102, 104, 106 to create a virtual drive on virtual machine 105. In one embodiment, a user of a client device 102, 104, 106 may want to create a virtual drive with specific access controls. For example, a user may want to limit the access to the virtual drive to him/herself. In another example, a user may want to limit the access to the virtual drive to a community-of-interest, e.g., colleagues in the same office or departments, members of a team, etc. Thus, the request at 305 may include parameters for setting up the access control. These access control parameters at 305 may include the identities of the user/client devices that can access the virtual drives, the capacity of those user/client devices, e.g., read, write, delete, etc.

The method 300 includes 310 creating, by the MCU, a partition on one or more physical hard drives accessible by the emulated machine, the partition providing machine readable memory to support functionalities of the virtual drive. In one embodiment, according to the request, the MCU 108 creates a partition on one or more physical hard drives accessible by the virtual machine 150. This partition provides machine readable memory to support the functionalities of the virtual drive created. In one embodiment, this virtual drive is a file hosted on the physical hard drive. In one embodiment, this partition can be hosted on a single hard drive. In another embodiment, this partition can he hosted on a plurality of hard drives, e.g., cloud storage. In one embodiment, this partition has a fixed size. In another embodiment, this partition is scalable based on demands.

The method 300 includes 315 creating, by the MCU, an identifier, e.g., an access key, a serial number, etc., for the virtual drive. In one embodiment, the MCU 108 creates an identifier, e.g., an access key, for the virtual drive. This identifier may include a name, a serial number, a logical identifier, an access key, etc. The access key can also be used for encryption/decryption functionalities to establish an encrypted communication over the virtual communication channel between a client and a specific drive. This access key may be private to the client. In another embodiment, this access key can be public. In yet another embodiment, the access key can be shared among a community-of-interest.

At 320, the MCU 108 establishes a virtual communication channel for the virtual drive newly created. The virtual communication channel for the virtual drive is established, at least in part, using the identifier, e.g., the access key. In one embodiment, this means the information conveyed on the specific virtual channel is encrypted using the identifier, e.g., the access key. In another embodiment, this means when requesting information from the virtual drive, the request may include the access key. In one embodiment, a system includes multiple virtual communication channels. Each virtual channel has a specific access key associated with the virtual channel. A request for data access must specify the access key for the intended virtual drive.

In one embodiment, when a virtual channel is established, there can be a plurality of access keys associated with the channel granting different level of accesses. For example, a master key if presented by the requestor, the requestor can have full capacity to the virtual drive, e.g., read, write, delete, edit, etc. In another example, a read only key when presented by the requestor, the requestor can only read the files on the virtual drive. In another embodiment, a read-and-write key when presented by the requestor, the requestor can read and write the file on the virtual drive, but cannot delete or edit existing files.

FIG. 4 is a method 400 to access a plurality of virtual drives through a plurality of virtual channels with a first-in first-out queue according to one embodiment of the disclosure.

The method 400 includes 405 receiving, by a processor of a multichannel control unit (MCU), a first request to access a first virtual drive (VD) of an emulated machine, the first request includes a first identifier of the VD, a first file indicator, an action indicator. In one embodiment, the client devices 102, 104, 106 may initiate a data access request to the MCU. In one embodiment, the request is specific to a first drive. This request may include a first identifier of the VD, a file indicator referring to the file-in-interest, and an action identifier specifying whether the client want to read, write, delete, or edit the file-in-interest.

The method 400 includes 410 creating a file handle for the first request, by the MCU, the file handle including a physical partition reserved for receiving data, the first identifier of the VD, the first file indicator, and the action indicator. In one embodiment, the file handle is a temporary storage space to receive the data returned from the first virtual drive.

The file handle may include metadata portion and received data portion. The metadata portion may include the first identifier of the VD, the first file indicator, and the action indicator specified in the request at 405. The received data portion can be a fixed partition or a scalable partition created to receive the data returned from the VD. The file handle can be created on any machine readable memory accessible by the MCU, e.g., RAM or hard drive. In one embodiment, after the data is received from the VD, the MCU sends the entire file handle back to the requester. In another embodiment, the MCU sends just the received data portion to the requester.

The method 400 includes 415 putting, by the MCU, the first request into a queue, wherein the first request takes a lower priority over a second request if the second request was put into the queue before the first request. At 415, the queue is a first-in first-out queue. Thus, if the second request is already in the queue before the first request, the second request takes priority over the first request. This means the second request will be processed before the first request. It is possible for method 400 to include a different type of queue that prioritizes the requests based on different factors, not just the time of arriving the queue.

The method 400 includes 420 sending, by the MCU, the second request to a second VD designated by the second request, wherein the second VD has a response latency T, the response latency T is a time period between the time the second request is sent by the MCU and corresponding data is received by the MCU. Because the queue is first-in, first-out, the second request which arrived at the queue earlier will be processed before the first request. The second request is a request to access a drive via a second virtual channel. The virtual drive has a response latency T. The first response will be sent during the latency T of the second virtual drive. This means the time gap Tg between the second request and the first request is shorter than the latency T of the second virtual drive. In one embodiment, the first request and the second request are sent over a single non-virtual communication channel.

The method 400 includes 425 sending, by the MCU, the first request, wherein a time interval, e.g., time gap Tg, between sending the second request and the first request is shorter than the response latency T. At 425, the concept is similar to the embodiment of FIG. 2B. It is possible to send a plurality of requests to one or more virtual drives during the response latency T period.

FIG. 5 is a method 500 to access a plurality of virtual drives through virtual communication channels with a prioritized queue according to one embodiment of the disclosure.

The method 500 includes 505 receiving, by a processor of a multichannel control unit (MCU), a first request to access a first virtual drive (VD) of an emulated machine, the first request includes a first identifier of the VD, an access priority, a first file indicator, an action indicator. In one embodiment, the client devices 102, 104, 106 may initiate a data access request to the MCU. In one embodiment, the request is specific to a first drive. This request may include a first identifier of the VD, a file indicator referring to the file-in-interest, and an action identifier specifying whether the client want to read, write, delete, or edit the file-in-interest.

At 505, the request includes an access priority. This access priority allows a client or a system to prioritize the access, especially when there are multiple requests lining up in a queue. In one embodiment, the access priority may be set according to the importance of the task. In another embodiment, the access priority may be set according to the requestor's membership level, e.g., different level of subscription fees.

In one embodiment, the access priority are in three levels: low, medium, high. The data access request with high priority will be processed before medium and low priority. The data access request with medium priority will be processed before low priority.

The method 500 includes 510 creating a file handle for the first request, by the MCU, the file handle including a physical partition reserved for receiving data, the first identifier of the VD, the first file indicator, and the action indicator. In one embodiment, the file handle is a temporary storage space to receive the data returned from the first virtual drive.

The file handle may include metadata portion and a received data portion. The metadata may include the first identifier of the VD, the first file indicator, and the action indicator specified in the request at 405. The received data portion can be a fixed partition or a scalable partition created to receive the data returned from the VD. The file handle can be created on any machine readable memory accessible by the MCU, e.g., RAM or hard drive. In one embodiment, after the data is received from the VD, the MCU send the entire file handle back to the requester. In another embodiment, the MCU send just the received data portion to the requester.

The method 500 includes 515 lining up, by the MCU, the first request into a queue according to the access priority, wherein a request with a higher access priority is processed before a request with a lower access priority, wherein among a group of requests with a same access priority, a request arrived earlier at the queue will be processed earlier than a request arrived later, wherein a second request either has a higher priority over the first request or the second request arrived earlier at the que than the first request.

At 515, the queue is a prioritized queue. Requests are processed according to their designated access priority. Requests with the same priority is processed first-in first-out. Thus, if the second request has a same access priority level and is already in the queue before the first request, then the second request takes priority over the first request.

The method 500 includes 520 sending, by the MCU, the second request to a VD via a second virtual channel designated by the second request, wherein the VD has a response latency T, the response latency T is a time period between the time the second request is sent by the MCU and corresponding data is received by the MCU. As in 515, because the second request either has a higher access priority or the second request arrived at the queue earlier than the first request. Thus, the second request will be processed before the first request. The second request is a request to access the virtual drive. The virtual drive has a response latency T. The first response will be sent during the latency T of the second virtual drive. This means the time gap Tg between the second request and the first request is shorter than the latency T of the second virtual drive. The two concurrent requests may be issued to the same VD or two different VDs via two different virtual channels.

The method 500 includes 525 sending, by the MCU, the first request, wherein a time interval, e.g., time gap Tg, between sending the second request and the first request is shorter than the response latency T. At 425, the concept is similar to the embodiment of FIG. 2B. It is possible to send a plurality of requests to one or more virtual drives during the response latency T period.

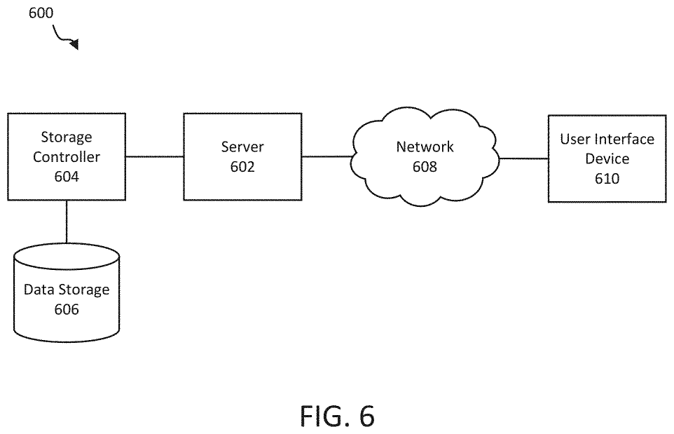

FIG. 6 illustrates a computer network 600 for obtaining access to database files in a computing system according to one embodiment of the disclosure. The system 600 may include a server 602, a data storage device 606, a network 608, and a user interface device 610. The server 602 may also be a hypervisor-based system executing one or more guest partitions hosting operating systems with modules having server configuration information. In a further embodiment, the system 600 may include a storage controller 604, or a storage server configured to manage data communications between the data storage device 606 and the server 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other mobile communication device having access to the network 608. In a further embodiment, the user interface device 610 may access the Internet or other wide area or local area network to access a web application or web service hosted by the server 602 and may provide a user interface for enabling a user to enter or receive information.

The network 608 may facilitate communications of data between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

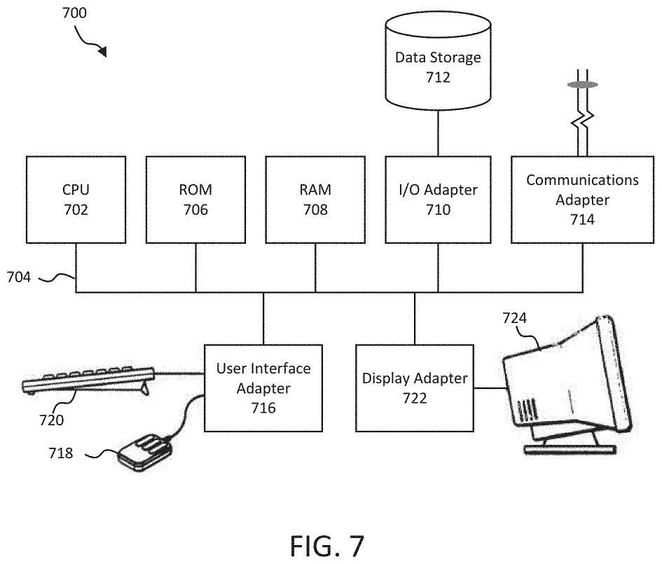

FIG. 7 illustrates a computer system 700 adapted according to certain embodiments of the server 602 and/or the user interface device 710. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 may also include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an I/O adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 824, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to the network 608, which may be one or more of a LAN, WAN, and/or the Internet. The user interface adapter 716 couples user input devices, such as a keyboard 720, a pointing device 718, and/or a touch screen (not shown) to the computer system 700. The display adapter 722 may be driven by the CPU 702 to control the display on the display device 724. Any of the devices 702-722 may be physical and/or logical.

The applications of the present disclosure are not limited to the architecture of computer system 700. Rather the computer system 700 is provided as an example of one type of computing device that may be adapted to perform the functions of the server 602 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

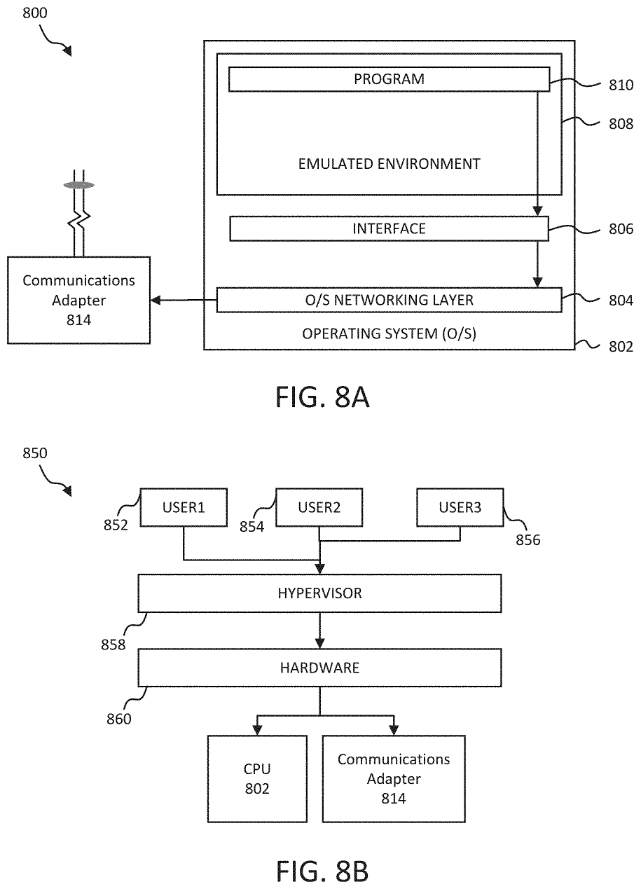

FIG. 8A is a block diagram illustrating a server hosting an emulated software environment for virtualization according to one embodiment of the disclosure. An operating system 802 executing on a server includes drivers for accessing hardware components, such as a networking layer 804 for accessing the communications adapter 814. The operating system 802 may be, for example, Linux or Windows. An emulated environment 808 in the operating system 802 executes a program 810, such as Communications Platform (CPComm) or Communications Platform for Open Systems (CPCommOS). The program 810 accesses the networking layer 804 of the operating system 802 through a non-emulated interface 806, such as extended network input output processor (XNIOP). The non-emulated interface 806 translates requests from the program 810 executing in the emulated environment 808 for the networking layer 804 of the operating system 802.

In another example, hardware in a computer system may be virtualized through a hypervisor. FIG. 8B is a block diagram illustrating a server hosting an emulated hardware environment according to one embodiment of the disclosure. Users 852, 854, 856 may access the hardware 860 through a hypervisor 858. The hypervisor 858 may be integrated with the hardware 858 to provide virtualization of the hardware 858 without an operating system, such as in the configuration illustrated in FIG. 8A. The hypervisor 858 may provide access to the hardware 858, including the CPU 802 and the communications adaptor 814.

If implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computing system, comprising
a computer executing an emulated operating system, the emulated operating system including a multichannel control unit;
a first virtual drive accessible to the emulated operating system;
a second virtual drive accessible to the emulated operating system; and
a physical communication channel, wherein a first set of virtual channels and a second set of virtual channels are established over the physical communication channel, the physical communication channel connects the multichannel control unit to the first virtual drive through the first set of virtual channels, and the physical communication channel connects the multichannel control unit to the second virtual drive via the second set of virtual channels,
wherein the multichannel control unit sends a first set of multiple data requests to the first virtual drive through the first set of virtual channels, the multichannel control unit sends a second set of multiple data requests to the second virtual drive through the second set of virtual drives.

2. The computing system according to claim 1, wherein the first virtual drive has a response latency, the response latency is a time period between a data access request is sent to the first virtual drive via a virtual channel and data requested is received from the first virtual drive.

3. The computing system according to claim 2, wherein
a time gap between a first data access request and a second data access request being sent is shorter than the response latency.

4. The computing system according to claim 3, wherein
the multichannel control unit receives the first data access request from a first client device, the multichannel control unit receives the second data access request from the second client device.

5. The computing system according to claim 1, the multichannel control unit comprising a queue, wherein the queue processes data access requests on a first-in first-out basis.

6. The computing system according to claim 1, the multichannel control unit comprising a queue, wherein the que processes data access requests based on a priority level designated for each data access request.

7. The computing system according to claim 1, wherein
the first data access request arrives at a queue of the multichannel control unit earlier than the second data access request, the first data request is processed earlier than the second data access request.

8. The computing system according to claim 1, wherein
the first data access request has a higher data access priority over the second data access request, the first data access request is processed earlier than the second data access request.

9. The computing system according to claim 1, wherein
the first data access request has a same data access priority over the second data access request, the first data access request arrives at a queue earlier than the second data access request, the first data access request is processed earlier than the second data access request.

10. The computing system according to claim 1, wherein
the multichannel control unit creates a first file handle for the first request, the file handle includes a metadata portion and a received data portion.

11. A computing system, comprising
a processor,
a machine readable memory accessible by the processor,
a communication channel connecting the computing system with the a plurality of virtual drives (VDs) via a plurality of virtual channels, wherein the machine readable memory stores instructions when executed cause the processor to perform following actions:
receiving a first request to access, via a virtual channel, a VD of an emulated machine;
creating a file handle for the first request;
putting the first request in a queue;
sending the first request to a VD through the first virtual channel of the communication channel;
sending a second request to a VD designated by the second request through the second virtual channel of the communication channel, wherein the VD has a response latency;
wherein an interval between sending the first request and the second request is shorter than the response latency.

12. The computing system according to claim 11, wherein the first request includes first identifier of the VD, a first file indicator, and an action indicator.

13. The computing system according to claim 12, including
creating a file handle for the first request, the file handle including a physical partition reserved for receiving data from the first VD.

14. The computing system according to claim 13,
the file handle including a metadata portion, the metadata portion including the first identifier of the VD, or the first file indicator, or the action indicator.

15. The computing system according to claim 11, wherein the first request is sent before the second request, if the first request arrives at the queue before the second request.

16. The computing system according to claim 1, wherein the second request is sent before the first request, if the second request has a data access priority higher than the first request, regardless of whether the first request arrived at the queue earlier than the second request.

17. The computing system according to claim 1, wherein the second request is sent before the first request, if the second request has a same data access priority as the first request and the second request arrived at the que earlier than the first request.

18. The computing system according to claim 1, wherein the first request is received by the computing system from a client device.

19. The computing system according to claim 1, wherein the first request includes a key unique to the first VD.

20. The computing system according to claim 19, wherein a communication between the computing system and the first VD is encrypted with the key.
